(19) United States
(12) Patent Application Publication
(10) Pub. No.: US 2007/0100730 A1
(43) Pub. Date: May 3, 2007

(54) NORMALIZATION ALGORITHM FOR IMPROVING PERFORMANCE OF MODULES DEPENDING ON PRICE FEED CHANGES IN REAL-TIME TRANSACTIONAL TRADING SYSTEMS

(75) Inventors: Dmitry Batashvili, New York, NY (US); Sergey Nekipelyy, New York, NY (US)

Correspondence Address: DMITRY BATASHVILI;SERGEY NEKIPELYY, 110-64 QUEENS BLVD, PMB #230, FOREST HILLS, NY, 11375, US

(73) Assignees: Dmitry Batashvili, New York, NY (US); Sergey Nekipelyy, New York, NY (US); TF NETWORK, INC., New York, NY (US)

(21) Appl. No.: 11/163,846

(22) Filed: Nov. 1, 2005

(51) Int. Cl. G07G 1/00; G06Q 40/00; G06F 17/30

(52) U.S. Cl. 705/37; 705/10

(57) ABSTRACT

The paper describes a method of improving the performance of modules detecting stop, limit, margin call, and other feed based conditions on accounts with individual feed settings. It provides a way of eliminating repetitive re-calculation of bid and asks values for accounts with individual feed settings. This significantly increases the system performance and decreases time of system reaction to the met condition. The algorithm is very useful for large brokerages and other financial real-time systems.

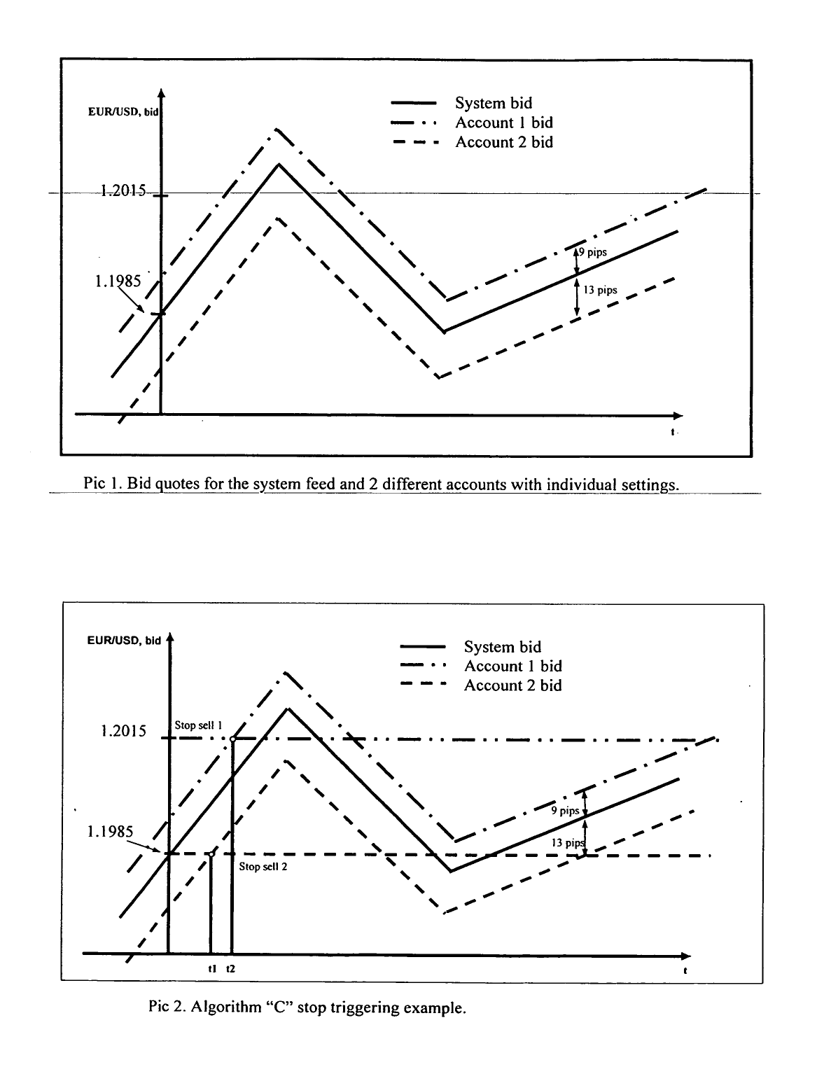

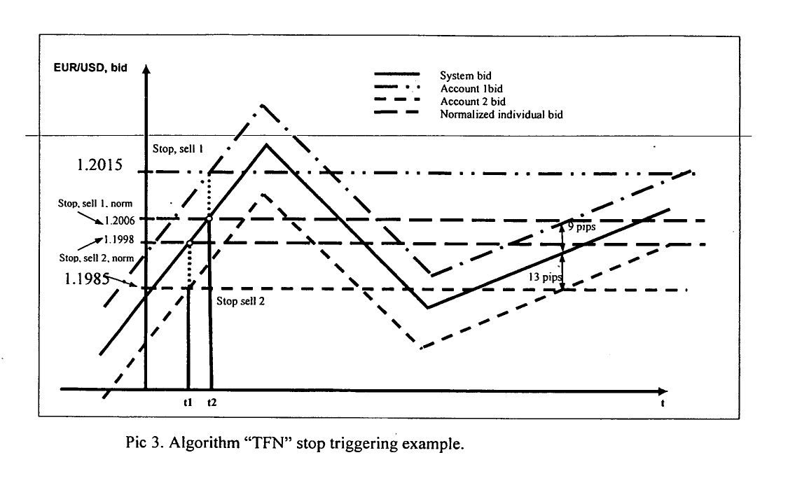

The invention defines an algorithm and structure of modules that allow significantly improving performance of the modules which have price quotes as an input parameter, for example Stop/Limit processing modules, margin call processing modules.

Intent

Improve performance of the feed based modules for accounts having individual feed settings. This allows having more orders processed in one given piece of hardware in comparison with conventional algorithms.

Problem Statement

Most trading system has accounts with individual feed settings. For example, some groups of account can have EUR bid at a level of 1.1990, another group can have a level 2 points higher at 1.1992 and another group can have it 3 pips lower at a level of 1.1987 at the same time. These levels' differences are determined by the company business policy. When a new price quote comes into the system the levels should be recalculated for each group so that the stop/limit and margin call levels of can be compared against the feed levels of the corresponding group. Picture 1 illustrates the system bid and 2 different accounts bids with individual settings which differ by 9 and 13 pips from the system feed.

Conventional algorithm of detecting the matched orders using sell stop as an example.

Below we will describe one of the conventional algorithms (let's call it “C”) that can be used in various trading systems. This algorithm is used for selecting a set of orders that have some trading conditions met i.e. stop/limit.

Initial data:

Client has open client positions on different instruments and different accounts. In the worst case performance scenario each open position has individual feed settings on an instrument and account level.

A conventional algorithm (“C”) of detecting triggered stop or limit on pending orders:
i. A trader sets some stop/value on her pending orders
ii. A new instrument quote tick is coming into the system
iii. The algorithm selects all the positions opened for this instrument
iv. The system processes orders one by one. For every order the value of the quote bid or ask is adjusted in accordance with the individual feed settings on the account
v. The stop/limit value is compared to the adjusted quite. If the stop/limit condition is met the order is marked as “condition met” and placed into the “condition met” queue for further processing.
vi. When all contracts are processed the “condition met queue” is sent for the matched orders processing in accordance with the business work-flow
vii. To speed-up the process the contracts may be sorted by account so number of individual settings related corrections can be reduced

As an example Picture 2 illustrates stop sell order 1 and stop sell order 2 places at levels of 1.2015 and 1.1985 correspondingly.

Stop 1 is set on account 1 and stop 2 is set on account 2. Account 1 bid value is 9 pips higher then the system bid and account 2 bid value is 13 pips lower than the system bid. So stop 1 value must be triggered when the account 1 bid reaches 1.2015 and stop 2 must be triggered when the account 2 bid level reaches 1.1985. When account 1 bid and account 2 bid values reach corresponding levels the system will detect that the conditions are met and it will process the orders in accordance with the business flow.

Performance Related Observations

The TF Network, Inc. algorithm allows to reduce the amount of computations required for selecting the condition met contracts. The idea is based upon analyzing the nature of the incoming feed behavior as well as analyzing the patterns of traders setting stops and limits.

Below are the observations made:

Observation 1:

The tradable instrument quote ticks are coming into the system quite often during active market periods. Sometimes ticks can come at a rate of 3-4 per second per instrument.

Observation 2:

Traders do not change stop/limit values on the contracts and pending orders often. An active trader can change the value 1 time in about 10-20 seconds during the pick of active market hours.

When analyzing algorithm “C” presented above there was the major bottleneck—step (iv) identified. This step requires adjusting the quote bid and asks values in accordance with the individual spread settings on the account. This is the major resource consuming step due to the fact that it is performed for every tick and for every account having individual settings.

Based on the observations presented above and on the results of the analysis TF Network, Inc. has developed an algorithm which includes the following considerations.

Instead of adjusting the quote's bid and ask for every account every time a new tick is coming the stop/limit value should be normalized to the system bid and ask levels so the normalized values should take the individual settings into account. Then the normalized values are recorded in a separate table (let us call it TableN).

When the new tick comes into the system it is compared against the normalized values.

When the trader changes the value of the stop/limit the new normalized value is precalculated and stored into table TableN.

When the individual settings on the account are changed the new normalized values on all account's orders are pre-calculated and stored into table TableN.

So the modified algorithm will look in the following way:

Algorithm “TFN”:
i. A trader sets some stop/value on her open contracts or pending orders.
ii. The value set on the contract/order is adjusted in accordance with the account's feed individual settings and stored into TableN. So if the trader set a stop value the system will create a record in table TableN corresponding to the order/contract, value type (stop/limit) and instrument.
iii. A new instrument quote tick is coming into the system.
iv. The quote bid/ask is compared against the pre-calculated normalized values stored in table TableN. If the stop/limit condition is met the contract is marked as “condition met” and placed into the “condition met” queue.
v. When all contracts are processed the “condition met queue” is sent for further processing in accordance with the business work-flow.

### BRIEF DESCRIPTIONS OF THE SEVERAL VIEWS OF THE DRAWINGS

[Picture 1]

Picture 1 displays the situation when 2 accounts have different individual settings thus each account has bid and ask values different from the bid and ask values coming into the system. For example, the feed coming from the clearing house is displayed with a solid line. On the trading console the trader 1 will see the feed 9 pips higher and trader 2 will see the 13 pips lower. The values are just a sample values and determined by the business rules of the brokerage house.

Picture 2.

This picture reflects the standard way of determining that the stop/limit conditions are met.

For example, the feed coming from the clearing house is displayed with a solid line. On the trading console the trader 1 will see the feed 9 pips higher and trader 2 will see the 13 pips lower. The values are just a sample values and determined by the business rules of the brokerage house.

Trader 1 has a stop placed at a level of 1.2015 and trader 2 has a stop value placed at a level of 1.1985. Feed values for account 1 and account 2 are calculated with every tick coming from the clearing house. Then they are compared with the stop values and if the stop conditions are met the system creates corresponding event. In this case when the account feed values become greater then the stop values the conditions are considered met. In our example the conditions are met at times t1 and t2 for account 2 and account 1 correspondingly.

Picture 3.

This picture reflects “TFN” algorithm of determining that the stop/limit conditions are met.

For example, the feed coming from the clearing house is displayed with a solid line. On the trading console the trader 1 will see the feed 9 pips higher and trader 2 will see the 13 pips lower. The values are just a sample values and determined by the business rules of the brokerage house.

Trader 1 has a stop placed at a level of 1.2015 and trader 2 has a stop value placed at a level of 1.1985. Instead of comparing the stop values with individual account feed values the system creates normalized value of stops at levels of 1.2015 and 1.1998 which differ from the original values for the value of individual settings (9 and 13 pips correspondingly). Then the values are compared with the system feed (displayed with solid line) on every tick. This eliminates the calculation overhead.

In this case when the account feed values become greater then the stop values the conditions are considered met. In our example the conditions are met at times t1 and t2 for account 2 and account 1 correspondingly.

So as one can see from the algorithm “TFN” the most resource intensive step—step “iv” of algorithm “C” is: eliminated. Besides, “TFN” step “iv” can be processed as one operation (for example as one SQL query) unlike similar algorithm “C” step “v” which requires iterating through all contracts one by one.

Picture 3 shows an example of the TFN algorithm in action.

The stop values are set at the same levels as on picture 2. The values of normalized values of stop 1 and stop 2 are precalculated at the moment when the trader sets the values on the orders. The values are calculated as
StopN1=Stop1bid−(Account1 bid−System bid)=1.2015−(0.0009)=1.2006.
StopN2=Stop2bid−(Account2 bid−System bid)=1.1985−(0.0013)=1.1998.

These values are stored into TableN.

When the new tick comes it is compared against the record in TableN. In our example if the value becomes greater than 1.1998, order 2 is processed. And when the value becomes greater than 1.2006, order 1 is processed.

Due to the fact that all values in TableN are pre-calculated, the comparison process can be implemented as one request for all pending orders/open contracts. This significantly reduces the resource consumption.

The above described algorithm can be used in stop, limit margin call and other even processing modules.

What is claimed is:

1. Algorithm “TFN” provided in section Description Para 6.

2. The idea of pre-calculating normalized values of stop, limits, mc levels etc. in advance to eliminate the requirement to calculate the real-time (adjusted in accordance with individual feed settings) values of quotes bid and ask at the moment the quotes come into the system.
